(19) United States
(12) Patent Application Publication
(10) Pub. No.: US 2004/0105011 A1
(43) Pub. Date: Jun. 3, 2004

(54) Photographic device with short total trace

(76) Inventors: Yin-Chun Huang, Hsin-Chu City (TW); Chih-Wen Huang, Hsin-Chu City (TW)

Correspondence Address: Nath & Associates, PLLC, Sixth Floor, 1030 15th Street, N.W., Washington, DC, 20005, US

(21) Appl. No.: 10/307,395

(22) Filed: Dec. 2, 2002

(51) Int. Cl. H04N 5/225

(52) U.S. Cl. 348/218.1

(57) ABSTRACT

A photographic device with a short total trace is disclosed in the present invention. By employing a special design in the image sensor of this invention, the image quality will not be decreased with the decreasing of the total trace of the photographic device, thus the image quality of the photographic device with a short total trace of this invention can be improved. Hence, this invention can efficiently improve the image quality of a photographic device with a short total trace.

### BACKGROUND OF THE INVENTION

1. Field of the Invention

This present invention relates to a photographic device, and more particularly, to a photographic device with short total trace.

2. Description of the Prior Art

For a photographic device, it is important to keep the quality of the image captured by the photographic device. But, while the total trace decreases with the size of the photographic device, the image in the vicinity of the edge of a target will become blurred.

For example, when a photographic device employs a charge-coupled device (CCD) as the image sensor, the photographic device can obtain the high quality image. Nevertheless, limited to the nature of the CCD, when the total trace of the photographic device is decreased, the image in the vicinity of the edge of the target will become blurred by the angle between the target and the lens of CCD. FIG. 1 shows a photographic device of the prior art employing a CCD as the image sensor. The image of the target 100 achieves the CCD 140 after crossing the lens 120. However, when the total trace decreases with the size of the photographic device, only the image of the portion 105 in the vicinity of the center of the target 100 is clear on the CCD 140. The image of the portions 110 in the vicinity of the edge of the target 100 is blurred on the CCD 140.

Hence, with the decreasing size of a photographic device, when improving the quality of the image captured by the photographic device, it is an important object to provide a photographic device with a short total trace, without any blurred images captured by the above-mentioned photographic device with short total trace.

### SUMMARY OF THE INVENTION

In accordance with the present invention, a special design of the image sensor is provided for improving the image quality of a photographic device with short total trace. Even though the total trace is decreased, the photographic device with short total trace of this invention can still obtain a whole and clear image.

It is another object of this invention to improve the quality of the image by employing the design of the image sensor of the photographic device with short total trace according to this invention, wherein the photographic device with short total trace is a reflective photographic device.

It is still another object of this present invention to improve the quality of the image by employing the design of the image sensor of the photographic device with short total trace according to this invention, wherein the photographic device with a short total trace is a transmission photographic device.

In accordance with the above-mentioned objects, the invention provides a photographic device with a short total trace. According to this prevent invention, the quality of the image captured by the photographic device with short total trace can be improved by employing at least two image sensors in the photographic device. In one case of this invention, a photographic device may employ a high-resolution image sensor to capture the major image of a target, and a low-resolution image sensor to capture the minor image of the target, wherein said minor image may be blurred on the high-resolution image sensor. Therefore, the high quality image can be obtained by the design of this invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram showing a photographic device with a short total trace employing a CCD as the image sensor according to the prior art;

FIG. 2 is a diagram of a photographic device with a short total trace according to the present invention; and

FIG. 3 is a diagram of another photographic device with a short total trace according to this present invention.

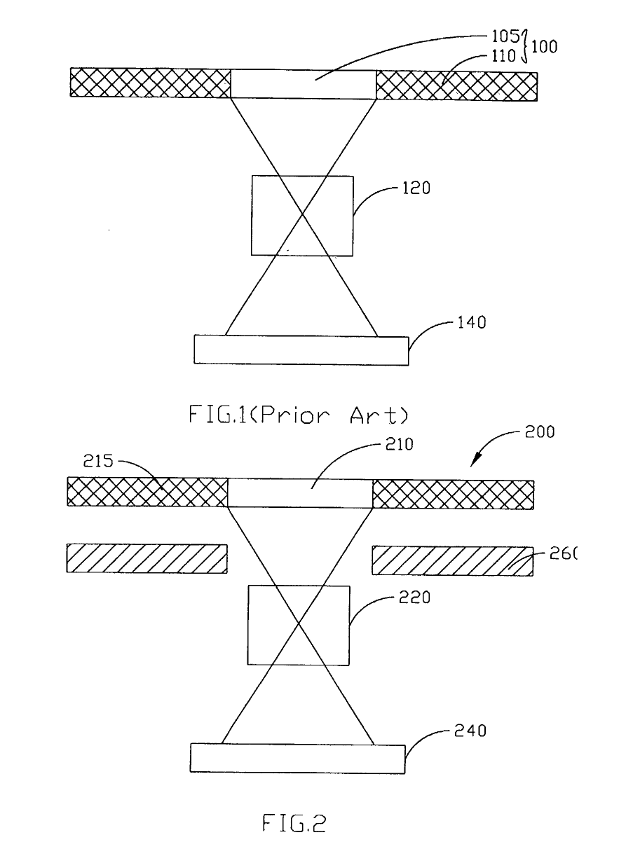

### DESCRIPTION OF THE PREFERRED EMBODIMENTS

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

Then, the components disclosed in this application are not shown to scale. Some dimensions are exaggerated to the related components to provide a more clear description and comprehension of the present invention.

One preferred embodiment of this invention is a photographic device with short total trace (TT). The above-mentioned photographic device comprises a first image sensor for capturing the first portion of a targeted image, at least a second image sensor for capturing the second portion of the targeted image, and a processor for combining the images captured by the first and the second image sensors. The first image sensor may be a high-resolution sensor, such as a charge coupled device (CCD). The second image sensor may be a low-resolution sensor, such as a contact image sensor (CIS). The target may be a document, a picture, or another object.

In this present embodiment, the photographic device with a short total trace may be a scanner. The above-mentioned photographic device with a short total trace may employ the CCD to capture the major image of the target, and employ the CIS to capture the minor image thereof, wherein the image may be blurred in the CCD. If only employing the CCD to capture all of the targeted image, the view of the angle between the portions of image in the vicinity of the edge of the target and the lens is too large to show the clear image on the portions of image in the vicinity of the edge of the target on the CCD. That is, in one case of this embodiment, the CIS is employed to help the CCD to capture the image of the target, and thus no portion of the image captured by the photographic device will become blurred by design. Moreover, because the above-mentioned photographic device with a short total trace employs a high-resolution sensor to capture the major image, and at least a low-resolution sensor to capture the minor image, the photographic device can obtain the high quality image with a short total trace according to this embodiment.

Another preferred embodiment of this present invention is a photographic device with short total trace. In one case of this embodiment, the above-mentioned photographic device may be a reflective photographic device, or a transmission photographic device. FIG. 2 shows the photographic device with a short total trace according to this embodiment. Referred to in FIG. 2, the above-mentioned photographic device with a short total trace comprises a first image sensor for capturing portion image of a target. At least a second image sensor for capturing the other image of the target, and a processor for combining the images captured by the first and the second image sensors to obtain the whole image of the target.

Referred to in FIG. 2, the photographic device with a short total trace employs a CCD 240 and two CIS 260 to capture the images of a target 200. The target 200 may be a document, a picture, or another object. The CCD 240 is employed to capture the image of the portion 210 in the vicinity of the center of the target 200. The CIS 260 is employed to capture the image of the portions 215 in the vicinity of the edge of the target 200. As shown in FIG. 2, the light from the portion 210 of the target 200 will cross the lens 220 and achieve the CCD 240.

In order to prevent the image of the portions 215 of the target 200 from becoming blurred on the CCD, the CIS 260 is employed to capture the image from the portions 215 of the target 200. In this manner, the photographic device with a short total trace of this embodiment can overcome the disadvantages from the image of the portion 215 in the vicinity of the edge of the target 200 from becoming blurred as mentioned in the prior art.

Compared with a CCD, CIS seems more suitable to be the image sensor of a photographic device with short total trace. However, the image quality captured by a CIS is not as good as the image quality captured by a CCD. From another point, even the image quality of a CCD is better than the image quality of CIS, the utility of a CCD in a photographic device with a short total trace is limited by the length of the total trace and the view angle between the target and the CCD. Through a special design of this invention, the image quality of the photographic device with a short total trace can be improved by employing both a CCD and CIS as image sensors.

According to this embodiment, the CCD 240 is employed to capture the image from the portion 210 in the vicinity of the center of the target 200. Two CIS 260 are employed to capture the image from the portion 215 in the vicinity of the edges from the target 200. Then, a processor, not shown in the figure, is employed to combine the images captured by the above-mentioned image sensors, CCD and CIS, to obtain the whole image of the target 200. In this manner, the photographic device of this embodiment can overcome the disadvantage at the edge portion of the image from becoming blurred while only employing a CCD as the image sensor. Preferably, the image quality of the photographic device with short total trace according to this embodiment is better than the photographic device with short total trace employing only a CIS as the image sensor.

Another preferred embodiment according to the present invention is a photographic device with a short total trace. In one case of this embodiment, the above-mentioned photographic device may be a reflective photographic device. The above-mentioned photographic device with short total trace comprises a first image sensor for capturing the image from the portion of the target in the vicinity of one edge of the target. A second image sensor for capturing a portion of the image in the vicinity of the other edge of the target; and a processor for combining the images captured by the first and the second image sensors to obtain the whole image of the target.

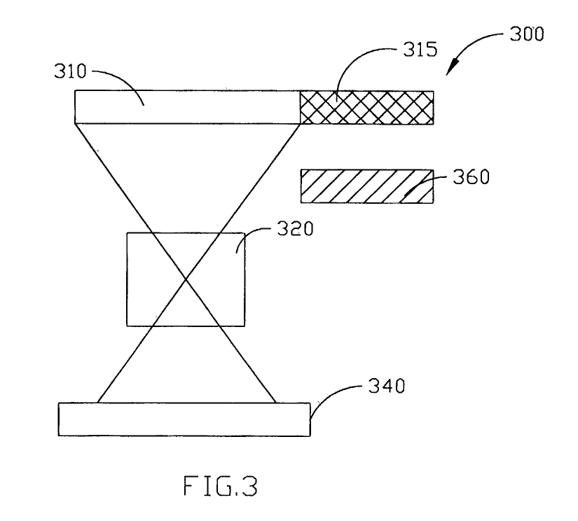

FIG. 3 shows a photographic device with short total trace according to this embodiment. Referred to in FIG. 3, the first image sensor may be a charge coupled device (CCD) 340. While employing the photographic device with a short total trace to capture the image, the first portion image 310, from the portion in the vicinity of the center of the target to one edge of the target 300, can cross the lens 320 and reach the CCD 340. In order to prevent the second portion image 315, in the vicinity of the other edge of the target 300, from becoming blurred on the CCD 340, the photographic device with a short total trace of this embodiment further comprises a second image sensor, such as a contact image sensor (CIS), for capturing the second portion image 315.

In this embodiment, a high-resolution image sensor, such as CCD, is employed to capture the image from the vicinity of the center of the target to one edge of the target, and a low-resolution image sensor, ex. CIS is employed to capture the image in the vicinity of the other edge of the target. That is, this embodiment employs a high-resolution image sensor to capture the major target of image, and a low-resolution image sensor to capture the other target of the image . Therefore, this embodiment can prevent the image in the vicinity of the edge of the target from becoming blurred in a photographic device with a short total trace. Moreover, after combining the images captured by the image sensors, a high quality image can be obtained by the photographic device with a short total trace of this embodiment.

According to the preferred embodiments, this invention discloses a photographic device with a short total trace. The above-mentioned photographic device comprises a first image sensor, at least a second image sensor, and a processor for combining the images captured by the first and the second image sensors. The first image sensor may be a high-resolution image sensor, and the second image sensor may be a low-resolution image sensor. The first image sensor is employed to capture the first portion of a targeted image, such as the image in the vicinity of the center of the target. The second image sensor is employed to capture the other image of the target, for example, the image in the vicinity of the targets edge. That is, the design of this invention may employ a high-resolution image sensor to capture the major image of the target, and a low-resolution image sensor to capture the minor image of the target. Thus, the design of this invention can overcome the defect in the prior art that some image becomes blurred on the image sensor. Hence, the design of this invention can efficiently improve the quality of the image captured by a photographic device with short total trace.

Although specific embodiments have been illustrated and described, it will be obvious to those skilled in the art that various modifications may be made without departing from what is intended to be limited solely by the appended claims.

What is claimed is:

1. A structure of a photographic device with short total trace, comprising:
a first image sensor for capturing a first portion image of a target;
a second image sensor for capturing a second portion image of said target; and
a processor for combining said images captured by said image sensors.

2. The structure according to claim 1, wherein said first image sensor is a high-resolution image sensor.

3. The structure according to claim 1, wherein said first image sensor is a charge coupled device.

4. The structure according to claim 1, wherein said second image sensor is a low-resolution image sensor.

5. The structure according to claim 1, wherein said second image sensor is a contact image sensor.

6. The structure according to claim 1, wherein said first image sensor is employed to capture the image of a portion in the vicinity of center of the target.

7. The structure according to claim 1, wherein said second image sensor is employed to capture the image of a portion in the vicinity of a edge of the target.

8. A structure of a photographic device, comprising:
a first image sensor for capturing a first portion image in the vicinity of center of a target;
at least a second image sensor for capturing a second portion image in the vicinity of edge of the target; and
a processor for combining said images captured by said first and said second image sensor.

9. The structure according to claim 8, wherein said first image sensor is a high-resolution image sensor.

10. The structure according to claim 8, wherein said first image sensor is a charge coupled device.

11. The structure according to claim 8, wherein said second image sensor is a low-resolution image sensor.

12. The structure according to claim 8, wherein said second image sensor is a contact image sensor.

13. A structure of a photographic device, comprising:
a first image sensor for capturing a first portion image from a portion in the vicinity of center of a target to one edge of said target;
at least a second image sensor for capturing a second portion image in the vicinity of the other edge of said target; and
a processor for combining said images captured by said first and said second image sensor.

14. The structure according to claim 13, wherein said first image sensor is a high-resolution image sensor.

15. The structure according to claim 13, wherein said first image sensor is a charge coupled device.

16. The structure according to claim 13, wherein said second image sensor is a low-resolution image sensor.

17. The structure according to claim 13, wherein said second image sensor is a contact image sensor.
